(19) United States
(12) Patent Application Publication
(10) Pub. No.: US 2016/0189168 A1
(43) Pub. Date: Jun. 30, 2016

(54) LICENSE MANAGEMENT SERVER AND LICENSE MANAGEMENT METHOD

(71) Applicant: KYOCERA Document Solutions Inc., Osaka (JP)

(72) Inventors: Takumi Nakamura, Osaka (JP); Takeshi Araya, Osaka (JP); Koki Nakajima, Osaka (JP); Hiromasa Akamatsu, Osaka (JP); Toru Yasui, Osaka (JP)

(73) Assignee: Kyocera Document Solutions Inc.

(21) Appl. No.: 14/938,804

(22) Filed: Nov. 11, 2015

(30) Foreign Application Priority Data
Dec. 26, 2014 (JP) 2014-264507

(51) Int. Cl. G06Q 30/00

(52) U.S. Cl. CPC G06Q 30/018

(57) ABSTRACT

In a license management server, a license management DB stores information about a license for performing remote maintenance on an image forming apparatus installed in an end customer site. A group management DB stores information about a group to which the image forming apparatus belongs. A table defines and describes the number of image forming apparatuses belonging to the group and a content of the license to be granted to the group so that the content of the license becomes advantageous to a user as the number of image forming apparatuses increases. The user registers the image forming apparatuses into the group. A group management unit counts the number of image forming apparatuses belonging to the group. A license management unit adjusts the content of the license on the basis of the number of image forming apparatuses counted.

### CROSS-REFERENCE TO RELATED APPLICATIONS

This application relates to and claims priority rights from Japanese Patent Application No. 2014-264507, filed on Dec. 26, 2014, the entire disclosures of which are hereby incorporated by reference herein.

### BACKGROUND

1. Field of the Present Disclosure

The present disclosure relates to a license management server and a license management method.

2. Description of the Related Art

Manufacturers of copying machines, multifunction peripherals (MFPs), printers, and the like (hereinafter, referred to collectively as image forming apparatuses) have made various contrivances to manage image forming apparatuses installed in customers' sites in a centralized manner. Examples include construction and provision of a management system.

For example, in a typical system, the customers' image forming apparatuses are not managed by respective service shops. Instead, a center is provided to manage the image forming apparatuses in an integrated manner. The center provides information for managing maintenance and inspection schedules, including the usages of the image forming apparatuses and peripheral equipment, to the service shops. This can reduce man-hours of the service shops for managing the customers' equipment.

In another typical system, a server obtains customer information about customers with which sales shops have traded in products, as well as product information. The server extracts other customers having the same attributes as those of the traded customers, and provides the product information about the traded products for sales shops in charge of the extracted customers.

A license contract to do maintenance and management of image forming apparatuses installed in end customers' sites by using a management system is subject to a fee. The license fee increases as the image forming apparatuses subject to the license contract increase. Sales companies and sales agents which are users of the management system are therefore not motivated to register more image forming apparatuses in the management system, and the number of image forming apparatuses registered in the management system is not large.

### SUMMARY

A license management server according to an aspect of the present disclosure includes: a license management DB configured to store information about a license for performing remote maintenance on an image forming apparatus installed in an end customer site; a group management DB configured to store information about a group that represents an organization for the license to be granted to and to which the image forming apparatus belongs; a table in which the number of image forming apparatuses belonging to the group and a content of the license to be granted to the group are defined and described so that the content of the license becomes advantageous to a user as the number of image forming apparatuses increases, the user registering the image forming apparatuses into the group; a group management unit configured to count the number of image forming apparatuses belonging to the group by using the group management DB; and a license management unit configured to refer to the table and adjust the content of the license on the basis of the number of image forming apparatuses counted.

A license management method according to an aspect of the present disclosure includes: counting, by using a group management DB configured to store information about a group that represents an organization for a license for performing remote maintenance and the like on an image forming apparatus installed in an end customer site to be granted to and to which the image forming apparatus belongs, the number of image forming apparatuses belonging to the group, the license being managed by a license management DB configured to store information about the license; and referring to a table in which the number of image forming apparatuses belonging to the group and a content of the license granted to the group are defined and described so that the content of the license becomes advantageous to a user as the number of image forming apparatuses increases, and adjusting the content of the license on the basis of the number of image forming apparatuses counted, the user registering the image forming apparatuses into the group.

These and other objects, features and advantages of the present disclosure will become more apparent upon reading of the following detailed description along with the accompanied drawings.

### BRIEF DESCRIPTION OF THE DRAWINGS

FIG. 1 is a diagram showing an example of an environment in which a license management server according to an embodiment of the present disclosure runs;

FIG. 2 is a diagram showing a concept of commission groups and normal groups;

FIG. 3 is a diagram showing a specific example of commission groups and normal groups;

FIG. 4 is a block diagram of a license management server 10 shown in FIG. 1;

FIG. 5 is a diagram showing a specific example of a function table 17c shown in FIG. 4;

FIG. 6 is a diagram showing a specific example of a grade table 17d shown in FIG. 4;

FIG. 7 is a diagram showing a specific example of a report number table 17e shown in FIG. 4;

FIG. 8 is a diagram showing a specific example of an own company ratio table 17f shown in FIG. 4; and

FIG. 9 is a flowchart showing license adjustment processing by the license management server 10 shown in FIG. 1.

### DETAILED DESCRIPTION

Hereinafter, an embodiment of the present disclosure will be described with reference to the drawings.

[Overall Configuration]

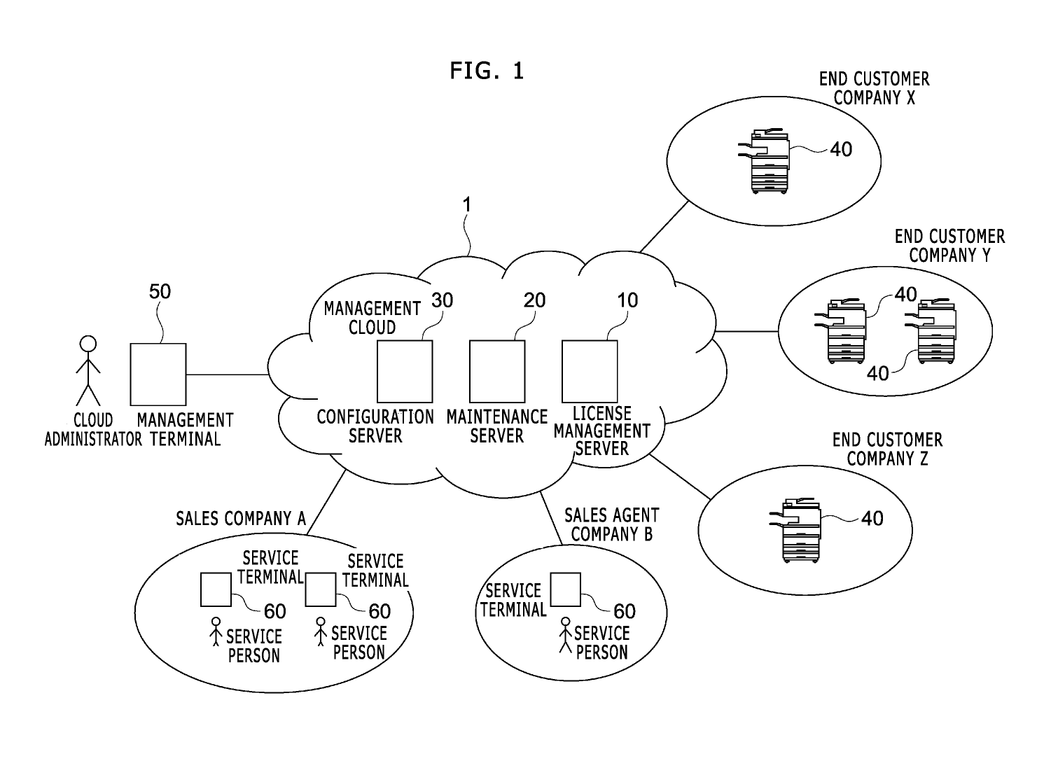

An example of an environment in which a license management server according to an embodiment of the present disclosure runs will initially be described. FIG. 1 is a diagram for describing an example of an environment in which a license management server 10 according to the embodiment of the present disclosure runs.

Image forming apparatuses 40 are installed in end customer companies X, Y, and Z which use the image forming apparatuses 40. The image forming apparatuses 40 are remotely managed from a management cloud 1 via a network.

The management cloud 1 includes a configuration server 30, a maintenance server 20, and a license management server 10. The configuration server 30 manages a configuration of the image forming apparatuses 40 of the end customers. The maintenance server 20 supports maintenance of the image forming apparatuses 40 of the end customers. The license management server 10 manages licenses for maintenance and the like of the image forming apparatuses 40 of the end customers.

A cloud administrator who manages the management cloud 1 accesses and manages the servers on the management cloud 1 from a management terminal 50.

Servicepersons (may include salespersons) of a sales company A and a sales agent company B serve as users of the management cloud 1 to perform maintenance and the like of the image forming apparatuses 40 of the end customers. The servicepersons access the management cloud 1 via service terminals 60, and perform remote maintenance and the like of the image forming apparatuses 40 installed in the customers' sites.

The example of the environment in which the license management server 10 according to the embodiment of the present disclosure has been described above.

[Commission Groups and Normal Groups]

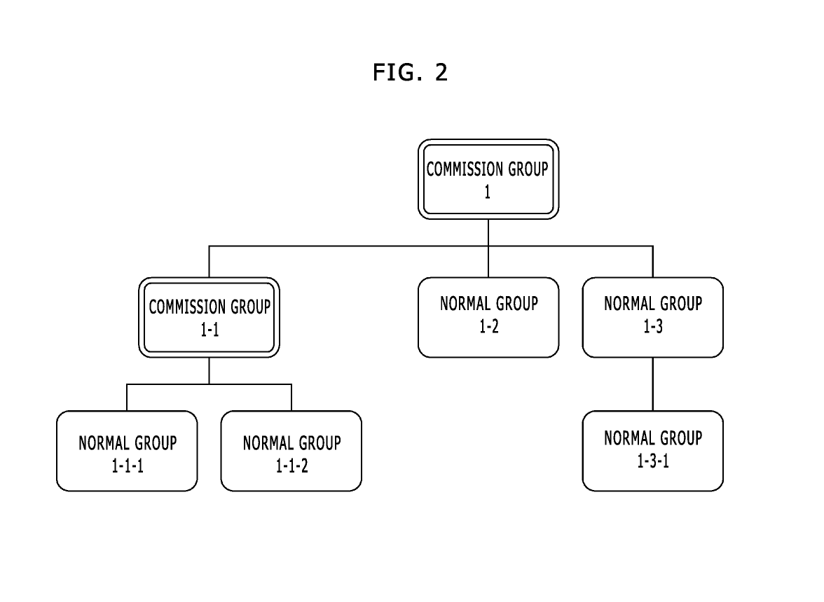

Next, a concept of commission groups and normal groups will be described. FIG. 2 is a diagram for describing the concept of commission groups and normal groups.

To manage licenses for performing maintenance and the like of the image forming apparatuses 40, the license management server 10 according to the embodiment of the present disclosure can employ, for example, a concept of commission groups (in the diagram, represented by commission groups 1 and 1-1) and normal groups (in the diagram, represented by normal groups 1-2, 1-3, 1-1-1, 1-1-2, and 1-3-1).

Commission groups and normal groups have a hierarchical tree structure.

A commission group is a unit in which to grant a license. A commission group is basically assumed to be an independent business organization. The foregoing users can belong to only commission groups.

A normal group is a group located under a commission group. The image forming apparatuses 40 to be managed belong to normal groups.

The vertical hierarchy in FIG. 2 basically represents an inclusion relationship of target areas.

The concept of commission groups and normal groups has been described above. While the groups here are divided into two types, commission groups and normal groups, such a configuration is not restrictive. For example, licenses may be granted to and the image forming apparatuses 40 may belong to groups of one type.

[Specific Example of Commission Groups and Normal Groups]

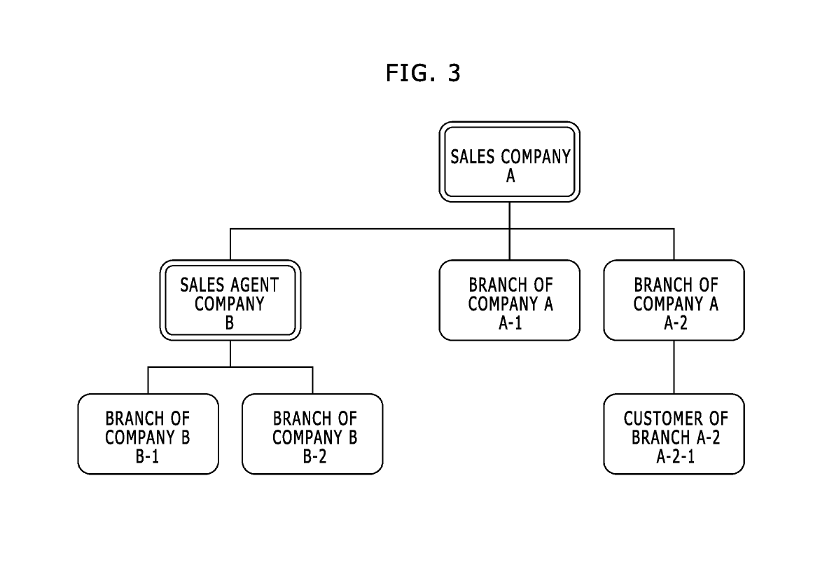

Next, a specific example of commission groups and normal groups will be described. FIG. 3 is a diagram for describing the specific example of commission groups and normal groups.

For example, the sales company A at the topmost level is a commission group. The sales agent company B serving as a commission group and branches A-1 and A-2 of the company A serving as normal groups are located under the sales company A.

A license granted to the sales agent company B is based on a contract between the sales company A and the sales agent company B.

The sales agent company B has branches B-1 and B-2 as subordinate normal groups.

The branch A-2 of the company A has a customer A-2-1.

Although omitted in FIG. 3, customers managed by the branches are located under the respective branches. The customers may be represented by normal groups.

A specific example of commission groups and normal groups has been described above.

[Configuration of License Management Server]

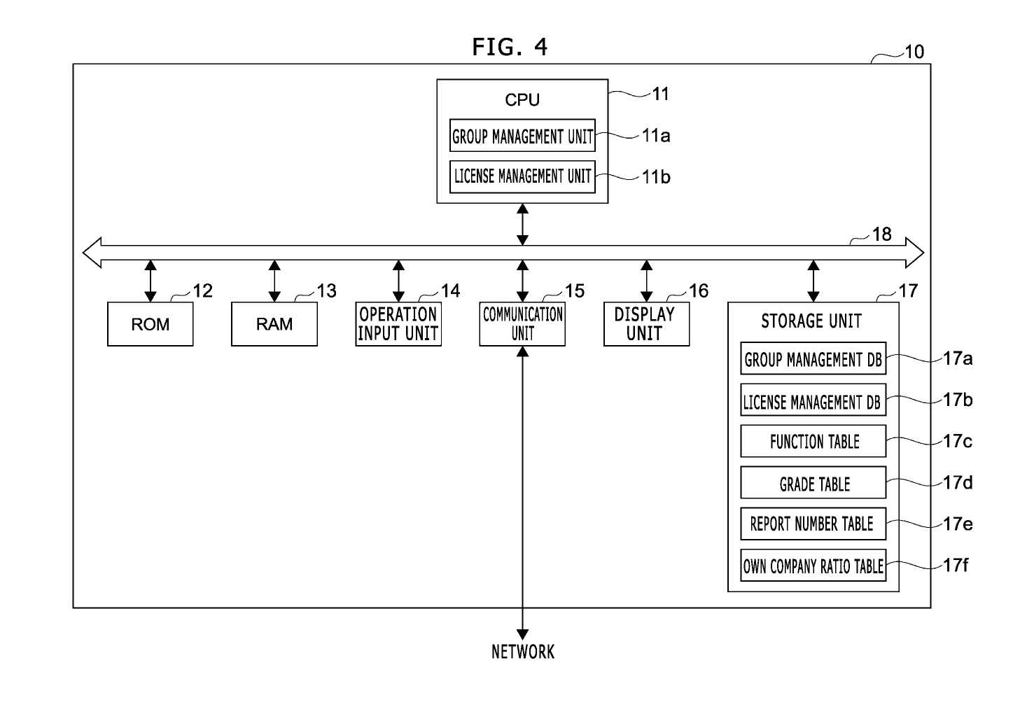

Next, a configuration of the license management server 10 will be described. The license management server 10 may be implemented by dedicated hardware and/or software. The license management server 10 may be implemented by a general computer. FIG. 4 shows a block diagram of the license management server 10 that is implemented by a general computer.

As shown in FIG. 4, the license management server 10 includes a central processing unit (CPU) 11, a read only memory (ROM) 12, a random access memory (RAM) 13, an operation input unit 14, a communication unit 15, a display unit 16, and a storage unit 17. Such blocks are connected via a bus 18.

The ROM 12 stores a plurality of programs such as firmware for performing various types of processing, and data. The RAM 13 is used as a working area of the CPU 11. The RAM 13 temporarily stores an operating system (OS), various applications running, and various types of data under processing.

Examples of the storage unit 17 include a hard disk drive (HDD), a flash memory, and other nonvolatile memories. The storage unit 17 stores the OS, various applications, various types of data, a group management database (DB) 17a for managing groups, a license management DB 17b for managing licenses, a function table 17c, a grade table 17d, a report number table 17e, and an own company ratio table 17f.

The group management DB 17a stores information and the like for managing commission groups and normal groups.

The license management DB 17b stores information and the like for managing granted licenses.

The function table 17c, the grade table 17d, the report number table 17e, and the own company ratio table 17f are tables to be referred to to adjust the contents of licenses granted to commission groups according to the numbers of image forming apparatuses belonging to (registered in) normal groups. Details of such tables will be described later.

The communication unit 15 is connected to a network for exchanging information with the maintenance server 20, the configuration server 30, the image forming apparatuses 40, the management terminal 50, and the service terminals 60.

The CPU 11 loads a program corresponding to a command given from the operation input unit 14 among the plurality of programs stored in the ROM 12 and the storage unit 17 into the RAM 13. According to the loaded program, the CPU 11 controls the display unit 16 and the storage unit 17 as appropriate.

Examples of the operation input unit 14 include a pointing device such as a mouse, and a keyboard, a touch panel, and other operation devices.

Examples of the display unit 16 include a liquid crystal display, an electro-luminescence (EL) display, and a plasma display.

Next, functional blocks implemented by the CPU 11 executing a program or programs will be described.

The functional blocks implemented by the CPU 11 of the license management server 10 are a group management unit 11a and a license management unit 11b.

The group management unit 11a manages groups by using the group management DB 17a. The group management unit 11a counts the numbers of image forming apparatuses 40 belonging to the respective normal groups under the commission groups, and notifies the license management unit 11b of the numbers of image forming apparatuses 40.

The license management unit 11b manages licenses to be granted to the commission groups by using the license management DB 17b.

The license management unit 11b refers to the numbers of image forming apparatuses 40 notified from the group management unit 11, and the function table 17c, the grade table 17d, the report number table 17e, and the own company ratio table 17f, and automatically adjusts the contents of the licenses granted to the commission groups.

In such a manner, the license management unit 11b automatically adjusts the contents of the licenses according to the numbers of image forming apparatuses 40 belonging to the normal groups. This can save the users re-concluding license contracts with the provider of the management system each time the numbers of image forming apparatuses 40 registered in the normal groups increase or decrease.

The configuration of the license management server 10 has been described above.

[Specific Example of Tables]

Next, a specific example of the function table 17c, the grade table 17d, the report number table 17e, and the own company ratio table 17f described above will be described.

(Function Table 17c)

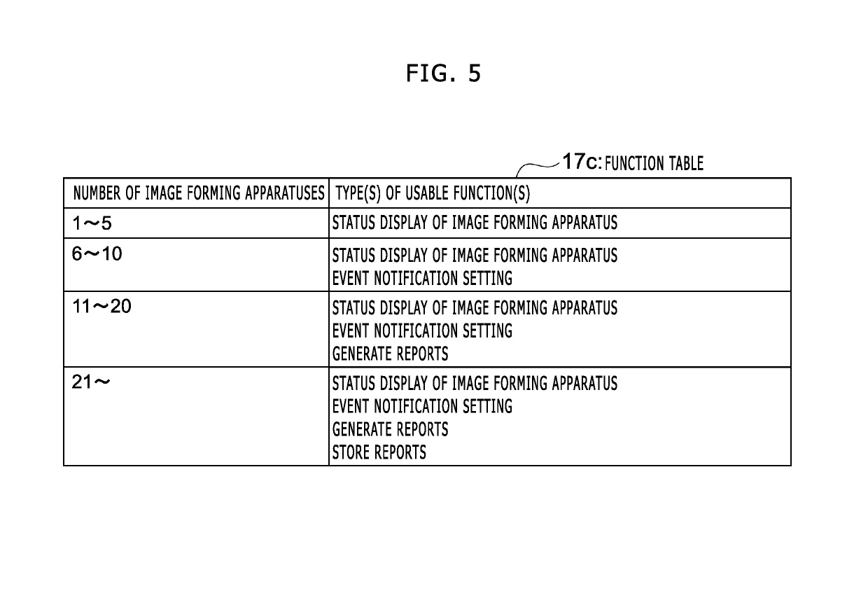

Initially, the function table 17c will be described. FIG. 5 is a diagram showing a specific example of the function table 17c.

As shown in FIG. 5, if the number of image forming apparatuses 40 registered in a normal group or groups under a commission group is one to five, the license granted to the commission group permits the use of only a function for status display of the image forming apparatuses 40 among functions of the management system 1.

If the number of image forming apparatuses 40 is six to ten, the use of a function for event notification setting for notifying the user of events occurring in the image forming apparatuses 40 is permitted in addition to the function for the status display of the image forming apparatuses 40.

If the number of image forming apparatuses 40 is eleven to twenty, the use of a function for generating reports is permitted in addition to the foregoing functions.

If the number of image forming apparatuses 40 is more than twenty, the use of a function for storing the generated reports is permitted in addition to the foregoing functions.

(Grade Table 17d)

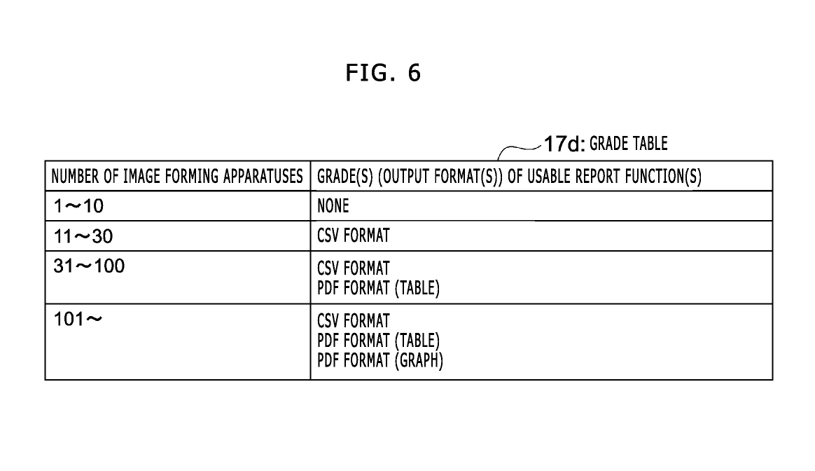

Next, the grade table 17d will be described. FIG. 6 is a diagram showing a specific example of the grade table 17d.

If the number of image forming apparatuses 40 is one to ten, no report is permitted to be generated.

If the number of image forming apparatuses 40 is eleven to thirty, reports are permitted to be generated only in a CSV format.

If the number of image forming apparatuses 40 is thirty-one to one hundred, reports are permitted to be generated in a CSV format and in a PDF format of table form.

If the number of image forming apparatuses 40 is more than one hundred, reports are permitted to be generated in a CSV format, a PDF format of table form, and a PDF format of graph form.

(Report Number Table 17e)

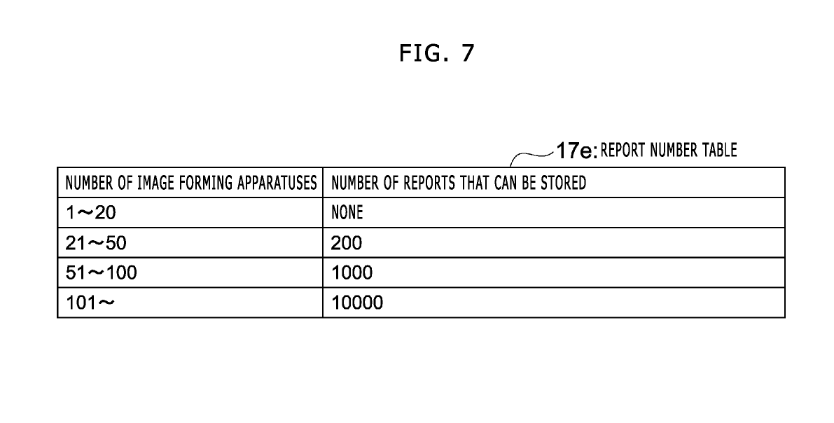

Next, the report number table 17e will be described. FIG. 7 is a diagram showing a specific example of the report number table 17e.

If the number of image forming apparatuses 40 is one to twenty, no reports generated are permitted to be stored.

If the number of image forming apparatuses 40 is twenty-one to fifty, up to 200 generated reports are permitted to be stored.

If the number of image forming apparatuses 40 is fifty-one to one hundred, up to 1000 generated reports are permitted to be stored.

If the number of image forming apparatuses 40 is more than one hundred, up to 10000 generated reports are permitted to be stored.

(Own Company Ratio Table 17f)

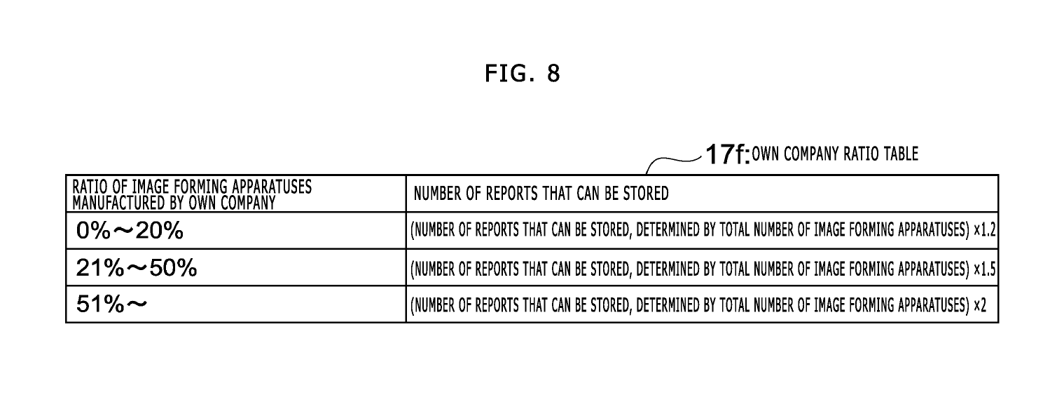

Next, the own company ratio table 17f will be described. FIG. 8 is a diagram showing a specific example of the own company ratio table 17f.

As employed herein, the own company ratio indicates the ratio of image forming apparatuses 40 manufactured by the own company, i.e., the provider of the management system to the image forming apparatuses 40 registered in the normal group(s) of the management system 1. The ratio may be in terms of the number of image forming apparatuses 40. The ratio may be in terms of the sales amounts of the image forming apparatuses 40.

If the ratio of the image forming apparatuses 40 manufactured by the own company is 0% to 20%, reports 1.2 times as many as the number of reports that can be stored, determined from the total number of image forming apparatuses 40 manufactured by the own company and other companies and the report number table 17e, are permitted to be stored.

If the ratio of the image forming apparatuses 40 manufactured by the own company is 21% to 50%, reports 1.5 times as many as the number of reports that can be stored, determined from the total number of image forming apparatuses 40 and the report number table 17e, are permitted to be stored.

If the ratio of the image forming apparatuses 40 manufactured by the own company is 51% or more, reports twice as many as the number of reports that can be stored, determined from the total number of image forming apparatuses 40 and the report number table 17e, are permitted to be stored.

(Effect of Table Setting)

As described above, the foregoing tables are defined so that the contents of the license become advantageous to the user as the number of image forming apparatuses 40 registered in the normal group(s) increases.

This can motivate the sales company or sales agent company to which the user belongs to register image forming apparatuses in the management system 1.

Most of the image forming apparatuses 40 that the sales company and the sales agent company register in the management system 1 are ones that the sales company and the sales agent company registering the image forming apparatuses 40 in the management system 1 sell to end customers. Successful motivation to increase the image forming apparatuses 40 registered in the management system 1 can thus provide motivation to increase the image forming apparatus 40 sold to end customers.

As described in the example of the own company ratio table 17f, the contents of a license are defined to be advantageous to the user as the ratio of the image forming apparatuses 40 manufactured by the company providing the management system 1 (own company) to the image forming apparatuses 40 registered in the management system 1 increases. This can enhance motivation to sell image forming apparatuses 40 manufactured by the own company rather than ones manufactured by other companies as image forming apparatuses 40 to be registered in the management system 1.

If the management system 1 is constructed on a public cloud, the data that needs to be retained on the public cloud to maintain the image forming apparatuses 40 increases as the image forming apparatuses 40 registered in the management system 1 increase. This increases the use fee of the public cloud.

However, the increased cost of the public cloud can be covered by sales profit if the number of sales of image forming apparatuses 40 manufactured by the own company increases.

A specific example of the function table 17c, the grade table 17d, the report number table 17e, and the own company ratio table 17f has been described above.

[Processing Flow]

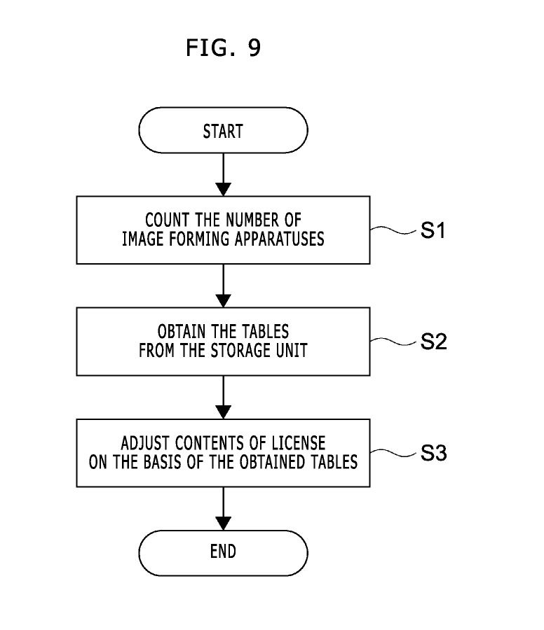

Next, a flow of license adjustment processing by the license management server 10 will be described. FIG. 9 is a flowchart for describing the flow of the license adjustment processing by the license management server 10.

Initially, the group management unit 11a searches the group management DB 17a to count the number of image forming apparatuses 40 registered in a normal group or groups under a commission group. The group management unit 11a notifies the license management unit 11b of the count result (step S1).

Next, the license management unit 11b obtains the tables for adjusting the contents of the license, namely, the function table 17c, the grade table 17d, the report number table 17e, and the own company ratio table 17f from the storage unit 17 (step S2).

Next, the license management unit 11b refers to the obtained tables, namely, the function table 17c, the grade table 17d, the report number table 17e, and the own company ratio table 17f, and adjusts the contents of the license on the basis of the count result of the image forming apparatuses 40 notified from the group management unit 11a (step S3).

The flow of the license adjustment processing by the license management server 10 has been described above.

The description has been presented for purposes of illustration and description, and is not intended to be exhaustive or limited.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. A license management server comprising:
a license management DB configured to store information about a license for performing remote maintenance on an image forming apparatus installed in an end customer site;
a group management DB configured to store information about a group that represents an organization for the license to be granted to and to which the image forming apparatus belongs;
a table in which the number of image forming apparatuses belonging to the group and a content of the license to be granted to the group are defined and described so that the content of the license becomes advantageous to a user as the number of image forming apparatuses increases, the user registering the image forming apparatuses into the group;
a group management unit configured to count the number of image forming apparatuses belonging to the group by using the group management DB; and
a license management unit configured to refer to the table and adjust the content of the license on the basis of the number of image forming apparatuses counted.

2. The license management server according to claim 1, wherein the number of image forming apparatuses and a type of a function usable by the remote maintenance are defined in the table.

3. The license management server according to claim 1, wherein the number of image forming apparatuses and an output format of a report generated by the remote maintenance usable are defined in the table.

4. The license management server according to claim 1, wherein the number of image forming apparatuses and the number of reports that are generated by the remote maintenance and can be stored are defined in the table.

5. The license management server according to claim 1, wherein a ratio of image forming apparatuses manufactured by a manufacturer providing the license management server to the image forming apparatuses registered in the group and a coefficient for increasing the number of reports that are generated by the remote maintenance and can be stored, determined from the number of image forming apparatuses, are further defined in the table.

6. A license management method comprising:
counting, by using a group management DB configured to store information about a group that represents an organization for a license for performing remote maintenance and the like on an image forming apparatus installed in an end customer site to be granted to and to which the image forming apparatus belongs, the number of image forming apparatuses belonging to the group, the license being managed by a license management DB configured to store information about the license; and
referring to a table in which the number of image forming apparatuses belonging to the group and a content of the license granted to the group are defined and described so that the content of the license becomes advantageous to a user as the number of image forming apparatuses increases, and adjusting the content of the license on the basis of the number of image forming apparatuses counted, the user registering the image forming apparatuses into the group.
